(19) United States
(12) Patent Application Publication
(10) Pub. No.: US 2002/0130293 A1
(43) Pub. Date: Sep. 19, 2002

(54) Deformable membrane valve apparatus and method

(76) Inventors: Dennis Cheney, Idaho Falls, ID (US); J.B. Hokanson, Idaho Falls, ID (US)

Correspondence Address: J. WINSLOW YOUNG, P.O. Box 1088, Centerville, UT, 84014-5088, US

(21) Appl. No.: 09/808,622

(22) Filed: Mar. 15, 2001

(51) Int. Cl. F16K 31/00

(52) U.S. Cl. 251/346

(57) ABSTRACT

A valve for a fluid conduit, the valve including two valve housings adapted to be matingly joined to form the valve. Each valve housing includes a valve membrane having a deformable reed valve formed therein. A raised boss on each reed valve is designed to engage the opposing raised boss to cause mutual opening of the opposed reed valves. The raised bosses are brought into engagement upon interlocking of the two valve housings. Releasing the interlock between the two valve housings displaces the two raised bosses to allow the respective reed valves to close prior to separating the two valve housing.

### BACKGROUND

1. Field of the Invention

This invention relates to a check valve system for a fluid coupling and, more particularly, to a novel check valve apparatus and method wherein each coupling half of the fluid coupling includes a deformable valve membrane that is operationally closed when the fluid coupling is uncoupled to thereby serve as a check valve for the coupling half The two deformable valve membranes are both mutually deformable and mutually activating to the open position when the coupling halves are joined to form the coupling.

2. The Prior Art

Numerous fluid-handling applications involve the transportation of fluids from one location to another through a flexible conduit. One particular example of such fluid transfer is that of urine collection from a patient. Typically, the patient is catheterized by a device commonly referred to in the art as a Foley catheter. The Foley catheter drains the urine into a urine collection reservoir so that the urine output can be monitored for flow rate, total quantity, coloration, etc. Frequently, the patient, although catheterized, is ambulatory which means that provision must be made for transporting the urine collection reservoir with the patient as the patient travels from place to place. However, there are occasions when it is simply not practicable for the patient to be in effect, “tethered” to the urine collection bag via the Foley catheter. Under these circumstances it is customary to occlude the Foley catheter with a clamp and then uncouple the catheter from the collection reservoir. This uncoupling step results in leakage of residual urine from the length of the uncoupled catheter between the clamp and the collection reservoir.

In view of the foregoing it would be an advancement in the art to provide a valving mechanism for a coupling in the tubing. It would be an even further advancement in the art to provide a valving mechanism that provides a check valve device in each coupling half, the check valve devices being mutually openable upon engagement of one coupling half to the corresponding coupling half to form the coupling. Another advancement in the art would be to provide a coupling having an automatic check valve feature in each coupling half to inhibit the flow of fluid when the coupling is opened. Such a novel apparatus and method is disclosed and claimed herein.

### BRIEF SUMMARY AND OBJECTS OF THE INVENTION

This invention is a novel valve apparatus and method for a coupling in a tubing wherein each coupling half includes a flexible membrane as a valving mechanism The flexible membrane acts as a check valve for the tubing when the coupling is opened. The flexible membranes in each coupling half are mutually deformable when forced together thereby causing each valve mechanism to be opened when the two coupling halves are joined to form the coupling.

It is, therefore, a primary object of this invention to provide a valving mechanism for a coupling in a tubing.

Another object of this invention is to provide a coupling having a pair of mutually activated valves.

Another object of this invention is to provide improvements in the method of providing a valving mechanism for a coupling in a tubing.

Another object of this invention is to provide a check valve in each coupling half of a two-part coupling to prevent leakage from each coupling half when the coupling is opened to disconnect the tubing.

Another object of this invention is to provide a valve mechanism for a coupling that is automatically opened when the coupling is closed.

Another object of this invention is to provide a deformable membrane in each coupling half of a coupling, the deformable membrane serving as a check valve for the coupling half to prevent the flow of fluid from the coupling half, the deformable membranes of the two coupling halves being mutually deformable to the open position when one coupling half is joined to the other coupling half to form the coupling.

These and other objects and features of the present invention will become more readily apparent from the following description in which preferred and other embodiments of the invention have been set forth in conjunction with the accompanying drawing and appended claims.

### BRIEF DESCRIPTION OF THE DRAWING

FIG. 1 is a perspective view of the novel coupling of this invention shown in the environment of a length of tubing;

FIG. 2 is an exploded, perspective view of the coupling of FIG. 1;

FIG. 3 is a cross-sectional view taken along lines 3-3 of FIG. 1 and showing the two valve membranes in juxtaposition upon joinder of the valve housings prior to interlocking the valve housings into the coupling; and

FIG. 4 is the cross-sectional view of FIG. 3 with the lower valve housing being rotated 90° to cause the mutually deformable valve membranes to open.

### DETAILED DESCRIPTION OF THE PREFERRED EMBODIMENT

The invention is best understood from the following description with reference to the drawing wherein like parts are designated by like numerals throughout and taken in conjunction with the appended claims.

### General Discussion

The novel fluid coupling apparatus and method of this invention is configured as a valve body having two valve housings designed to releasably mate to form the valve body. Each valve housing is formed as a hollow, hemispherical-like shell. A flexible valve membrane transects each hollow shell. A arcuate slit is formed in the valve membrane to provide an opening through the valve membrane when the valve membrane is selectively deformed to cause the slit to open. The slit, in effect, creates a reed-type valve in the valve membrane. A raised boss on the reed portion of the valve serves as the contact point for the imposition of distortional forces on the valve membrane to force the reed valve open. The natural resiliency of the material of construction of the valve membrane brings the reed valve to the closed position when the distortional forces are removed from the raised boss.

The two valve housings are designed to matingly and sealingly engage to create the valve body with the valve body sealingly enclosing the valve membrane of each valve housing. As part of the mating engagement between the two valve housings, a set of mating catches on each valve housing are designed to engage and releasably interlock upon a relative rotation between the two valve housings of about 90°. The 90° rotation causes a raised boss on each reed valve to forcibly engage the opposing raised boss to thereby cause each reed valve to be mutually opened under the resulting distortional forces imposed thereon. Reversal of the foregoing 90° rotation moves each raised boss away from the opposing raised boss to thereby allow the inherent resiliency of the respective reed valve to close the same prior to the two valve housings being separated.

### DETAILED DESCRIPTION

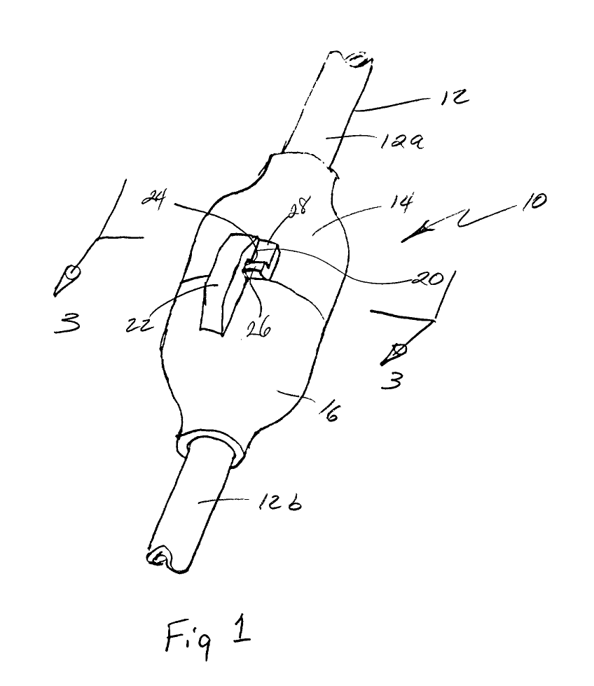

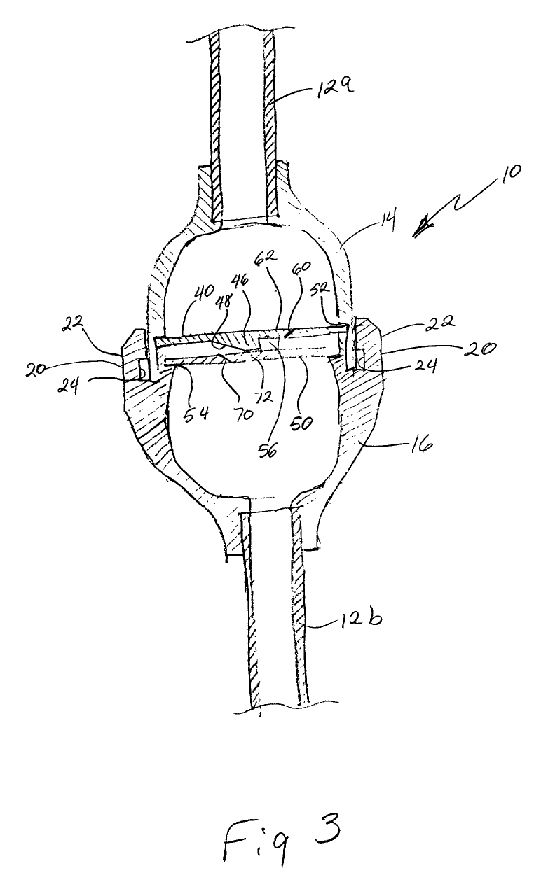

Referring now to FIG. 1, the novel fluid coupling apparatus of this invention is shown generally at 10 interposed in a length of conventional tubing 12 consisting of an upper tubing 12a and a lower tubing 12b. Coupling 10 is designed to be selectively openable and, as such, includes an upper valve housing 14 with a lower valve housing 16 matingly joined to upper valve housing 14. An interlock 20 (see also FIG. 3) is provided on opposite sides of coupling 10 to securely join lower valve housing 16 to upper valve housing 14. Each interlock 20 is configured as a spar 22 formed as an extension on the outer surface of lower valve housing 16. Spar 22 extends across a portion of upper valve housing 14. A transverse notch 24 in the face of spar 22 is designed to engage a raised lip 26 on upper valve housing 14. A detent 28 is formed as a portion of lip 26 to serve as a stop against which spar 22 rests when lower valve housing 16 is securely engaged to upper valve housing 14 as will be discussed more fully hereinafter.

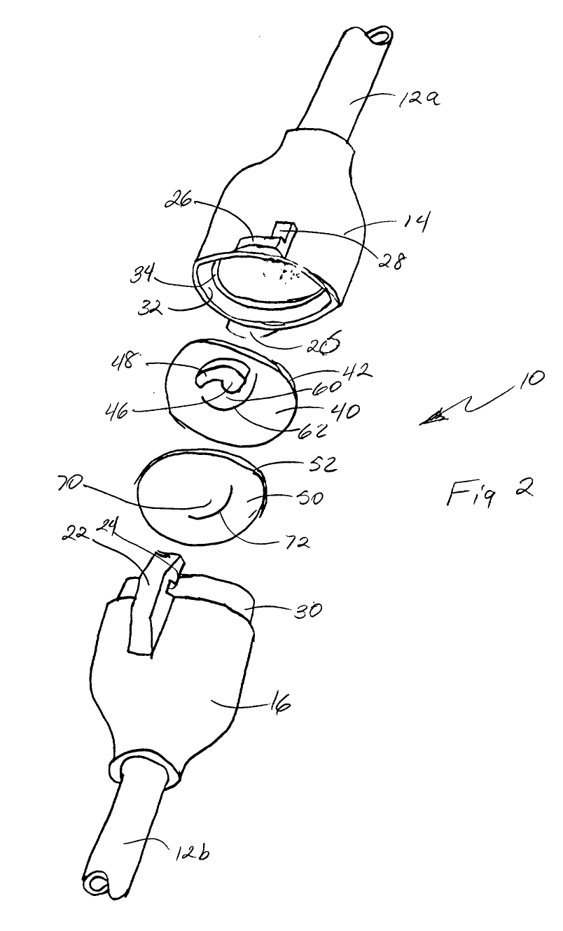

Referring now to FIG. 2, lower valve housing 16 includes a recessed, circumferential extension 30 while upper valve housing 14 includes a circumferential recess 32 that is dimensionally configured to receive circumferential extension 30 therein in a sealing relationship. The base of circumferential recess 32 serves as an upper seat 34 for an upper membrane valve 40 placed in upper valve housing 14. In particular, periphery 42 of upper membrane valve 40 is sealingly secured to upper seat 34 thereby completing the construct of upper valve housing 14. A similar seat, lower seat 54 (FIG. 3) is located inside lower valve housing 16 and is configured to have periphery 52 of a lower membrane valve 50 sealingly engaged thereto.

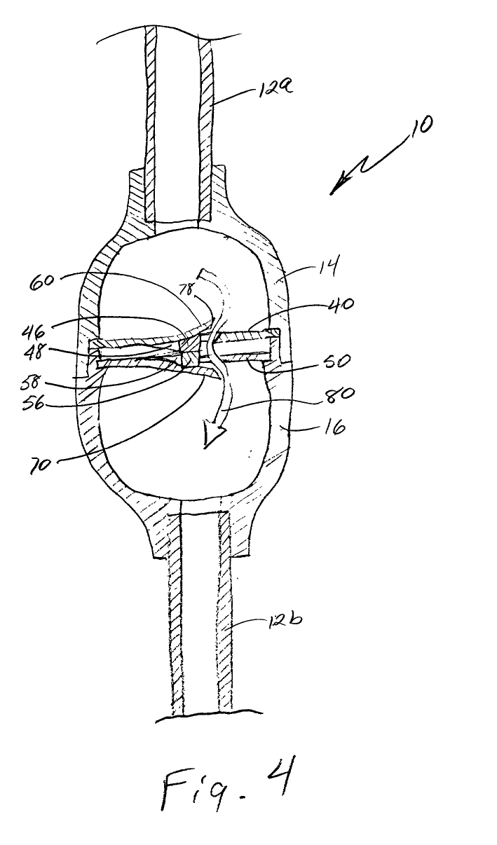

Upper membrane valve 40 is fabricated from an elastomeric material such as plastic, synthetic rubber, latex, or the like, and includes a valve slit 62 therein. Valve slit 62 is formed with an arcuate shape with the inner portion of the arcuate shape forming, in effect, a reed valve 60 that is selectively openable to permit passage of fluids through upper valve membrane 40. A raised boss 46 is formed on reed valve 60 to facilitate the opening of reed valve 60. An arcuate ramp 48 extends outwardly from raised boss 46, the function of which along with the operation of reed valve 60 will be discussed more fully hereinafter. Lower membrane valve 50 also has a reed valve 70 therein formed as a result of arcuate slit created through the elastomeric body of lower membrane valve 50. Reed valve 70 also includes a raised boss 56 (FIGS. 3 and 4) and an arcuate ramp 58 (FIG. 4) as an extension of raised boss 56.

Referring now to FIG. 3, upper valve housing 14 is shown slidingly joined to lower valve housing 16 prior to raised lip 26 (FIGS. 1 and 2) being rotatingly engaged in notch 24. In this particular configuration upper membrane valve 40 is held in spaced relationship to lower membrane valve 50 with raised boss 46 being held in abutment against lower membrane valve 50 while raised boss 56 is held in abutment against upper membrane valve 40. At this point it is important to emphasize that upper valve housing 14 is merely telescopically joined to lower valve housing 16 with the respective membrane valves, upper membrane valve 40 and lower membrane valve 50, sealingly enclosed within the confines of coupling 10. The configuration shown herein in FIG. 3 is the configuration of coupling 10 either immediately prior to separating upper valve housing 14 from lower valve housing 16 or immediately prior to interlocking upper valve housing 14 to lower valve housing 16. In both situations both of upper membrane valve 40 and lower membrane valve 50 are closed thereby preventing the flow of fluid 80 (FIG. 4) from either upper valve housing 14 or lower valve housing 16 as well as through coupling 10.

Referring now to FIG. 4, coupling 10 is shown in this cross-sectional view as having lower valve housing 16 rotated axially 90° relative to upper valve housing 14. This relative rotational movement causes raised boss 46 to engage raised boss 56 resulting in a mutually outward displacement of reed valve 60 and reed valve 70, respectively, thereby opening a flow path 78 for the flow of fluid 80 through coupling 10. Importantly, interlock 20 is created by the engagement of raised lip 26 in notch 24 (FIGS. 1, 2, and 3) to thereby securely engage upper valve housing 14 to lower valve housing 16 thus completing coupling 10. In this interlocked configuration coupling 10 readily and securely provides fluid communication between upper tubing 12a and lower tubing 12b for fluid 80. The patient (not shown) is thereby provided with a safe, secure coupling of upper tubing 12a and lower tubing 12b by coupling 10. In the event the patient desires to be temporarily disconnected from, say, lower tubing 12b, it is a simple procedure for either the patient or a medical professional (not shown) to simply rotate upper valve housing 14 relative to lower valve housing 16 thereby causing reed valves 60 and 70, respectively, to return to their closed positions shown in FIG. 3. This closed position occludes flow path 78 shutting off the flow of fluid 80 through coupling 10. Thereafter, upper valve housing 14 is simply disengaged from lower valve housing to allow the patient to be fully ambulatory. Importantly, upper membrane valve 40 is sealingly closed thereby preventing the leakage of fluid 80 from upper valve housing 14. Correspondingly, lower membrane valve 50 is also sealingly closed thereby preventing the reverse flow of fluid 80 from lower valve housing 16.

### The Method

The method of this invention is practiced by severing tube 12 and mounting upper valve housing 14 to the severed end of upper tubing 12a and lower valve housing 16 to the severed end of lower tubing 12b. Coupling 10 is initially created when upper valve housing 14 is telescopically joined to lower valve housing 16. Upon initial joinder of lower valve housing 16 to upper valve housing 14 both of lower membrane valve 50 and upper membrane valve 40 are automatically held in the closed position by the resiliency of the material of construction of each membrane valve. Rotational movement of lower valve housing 16 relative to upper valve housing 14 causes raised boss 56 to slide across arcuate ramp 48 and raised boss 46 to correspondingly slide across arcuate ramp 58 until raised boss 56 and raised boss 46 are in juxtaposition. This placement of raised boss 56 against raised boss 46 creates a mutual displacement of the respective reed valves upon which these raised bosses are formed, namely reed valves 70 and 60, respectively, to thereby create flow path 78 through coupling 10. Importantly, upper valve housing 14 is securely held to lower valve housing 16 by interlock 20 while flow path 78 is formed inside coupling 10. Reversal of the rotational formation of interlock 20 causes each of raised bosses 46 and 56 to disengage thereby allowing the respective reed valves 60 and 70 to close under the inherent resilience of the material of construction of these elements.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is.

1. A valve body for a fluid conduit comprising:
a first valve housing configurated as a first hollow shell;
a first membrane valve in said first valve housing;
a second valve housing configurated as a second hollow shell;
a second membrane valve in said second valve housing;
engagement means for releasably engaging said first valve housing with said second valve housing to create said valve body; and
deformation means in said valve body for mutually deforming said first membrane valve and said second membrane valve, said deformation means thereby opening said first membrane valve and said second membrane valve.

2. The valve body defined in claim 1 wherein said first membrane valve comprises a first valve member fabricated from a resilient material and having a first reed valve formed therein, said first reed valve being resiliently urged to a closed position by the resiliency of said resilient material.

3. The valve body defined in claim 2 wherein said second membrane valve comprises a second valve member fabricated from said resilient material and having a second reed valve formed therein, said second reed valve being resiliently urged to a closed position by the resiliency of said resilient material.

4. The valve body defined in claim 1 wherein said deformation means comprises a first raised boss on said first membrane valve and a second raised boss on said second valve membrane, said first raised boss and said second raised boss being mutually displaced upon engagement of said engagement means, said mutual displacement of said first raised boss and said second raised boss opening said first membrane valve and said second membrane valve.

5. A coupling comprising:
a first valve housing;
a first valve member in said first valve housing, said first valve member being configurated as a first elastomeric membrane transecting said first housing in a blocking relationship and having a first slit therein, said first elastomeric membrane being yieldably deformable to accommodate deformation of said first elastomeric membrane, said deformation of said first elastomeric membrane causing said first slit to open;
a second valve housing;
a second valve member in said second valve housing, said second valve member being configurated as a second elastomeric membrane transecting said second housing in a blocking relationship and having a second slit therein, said second elastomeric membrane being yieldably deformable to accommodate deformation of said second elastomeric membrane, said deformation of said second elastomeric membrane causing said second slit to open;
engagement means for releasably engaging said first valve housing to said second valve housing in a sealing relationship thereby forming said coupling with said first valve membrane being placed in abutment against said second valve membrane; and
deformation means in said coupling for deforming said first valve membrane to open said first slit and said second valve membrane to open said second slit when said first housing and said second housing are engaged in said sealing relationship, said open first slit and said open second slit thereby forming a fluid communication means through said first valve membrane and said second valve membrane and thereby through said coupling.

6. The coupling defined in claim 5 wherein said coupling is interposed in a conduit, said conduit comprising a first tubing and a second tubing, said first tubing being coupled in fluid communication with said first valve housing said first elastomeric membrane in said first valve housing forming a first closure to said first tubing, said second tubing being coupled in fluid communication with said second valve housing, said second elastomeric membrane in said second valve housing forming a second closure to said second tubing.

7. The coupling defined in claim 5 wherein said deformation means comprises a first raised surface on said first valve membrane and a second raised surface on said second valve membrane, said first raised surface and said second raised surface mutually engaging and mutually deforming said first valve membrane and said second valve membrane when said first valve housing is engaged to said is second valve housing by said engagement means, said mutual deforming said first valve membrane and said second valve membrane opening said first slit and said second slit and creating fluid communication through said coupling.

8. A method for providing a valve mechanism for selectively controlling the flow of fluid through a conduit comprising the steps of:
severing said conduit to provide a first conduit end and a second conduit end of said conduit;
attaching a first valve housing to said first conduit end and a second valve housing to said second conduit end;
preparing a first valve membrane by forming a first reed valve in said first valve membrane and a second reed valve in said second valve membrane;
raising a first raised boss on said first reed valve and a second raised boss on said second reed valve;
securing said first valve membrane in said first valve housing and said second valve membrane in said second valve housing, said first valve membrane inhibiting fluid flow through said first valve housing and said first conduit end, said second valve membrane inhibiting fluid flow through said second valve housing and said second conduit end;
forming a valve body by joining said first valve housing to said second valve housing in a sealing relationship thereby enclosing said first valve membrane and said second valve membrane inside said valve body; and
creating a flow path for the said flow of said fluid through said valve body by opening said first reed valve and said second reed valve.

9. The method defined in claim 8 wherein said creating step comprises mutually engaging said first raised boss with said second raised boss thereby mutually pushing open said first reed valve and said second reed valve.

10. The method defined in claim 9 wherein said mutually engaging step included releasably interlocking said first valve housing with said second valve housing.
